(19) United States
(12) Patent Application Publication
(10) Pub. No.: US 2026/0329480 A1
(43) Pub. Date: Oct. 22, 2026

(54) Active Command Regulation

(71) Applicant: Google LLC, Mountain View, CA (US)

(72) Inventors: Hsin Yu Chang, New Taipei City (TW); Aravind Matta, Bengaluru (IN); Anirban Majumder, Bengaluru (IN)

(73) Assignee: Google LLC, Mountain View, CA (US)

(21) Appl. No.: 19/694,618

(22) Filed: Jun. 1, 2026

(51) Int. Cl. G06F 3/06

(52) U.S. Cl. CPC G06F 3/0659; G06F 3/0604; G06F 3/0673

(57) ABSTRACT

Techniques and apparatuses are described for performing active command regulation. In example aspects, a memory controller includes a regulator that performs active command regulation. The regulator detects one or more conditions associated with an impending switching event that causes the memory controller to switch states (e.g., switch between a write state and a read state). Based on this detection, the regulator prevents the releasing of requests and the scheduling of activate (and corresponding precharge) commands prior to the occurrence of the switching event. This blocking mechanism avoids the scheduling of extra activate and precharge commands that can become unutilized (e.g., commands that occur without a corresponding data transfer). Through active command regulation, the memory controller can improve a power efficiency of a memory system while maintaining operational efficiency.

### SUMMARY

Techniques and apparatuses are described for performing active command regulation. In example aspects, a memory controller includes a regulator that performs active command regulation. The regulator detects one or more conditions associated with an impending switching event that causes the memory controller to switch states (e.g., switch between a write state and a read state). Based on this detection, the regulator prevents the releasing of requests and the scheduling of activate (and corresponding precharge) commands prior to the occurrence of the switching event. This blocking mechanism avoids the scheduling of extra activate and precharge commands that can become unutilized (e.g., commands that occur without a corresponding data transfer). Through active command regulation, the memory controller can improve a power efficiency of a memory system while maintaining operational efficiency.

### BRIEF DESCRIPTION OF DRAWINGS

Apparatuses and techniques for performing active command regulation are described with reference to the following drawings. The same numbers are used throughout the drawings to reference like features and components:

FIG. 1 illustrates an example environment in which active command regulation can be implemented;

FIG. 2 illustrates example implementations of a memory controller capable of performing active command regulation;

FIG. 3 illustrates an example flow diagram for performing active command regulation;

FIG. 4 illustrates an example timing diagram for performing aspects of active command regulation;

FIG. 5 illustrates example situations in which active command regulation can be implemented to support bank diversity;

FIG. 6 illustrates example situations in which active command regulation can be implemented to support rank diversity; and

FIG. 7 illustrates an example method for performing active command regulation.

### DETAILED DESCRIPTION

A memory system is a fundamental component of modern computing devices, serving as a repository for the data and instructions required by processors to execute computational tasks. To a user, the performance of a memory system can impact the speed, responsiveness, and overall experience of using a computing device. As limitations on available power can impact the utilization of the computing device, there is an increased demand for designing memory systems that consume less power and reduce overall power consumption of the computing device.

During operations, a memory system can be in a write state to service a group of write requests or in a read state to service a group of read requests. In some cases, the memory system is a multi-rank system that can concurrently service the group of write requests or the group of read requests across two or more ranks. A switching event can occur in which the memory system switches between the write state and the read state. To perform this switch, the memory system closes banks that are open and previously activated during the prior state. While in the write or read state, the memory system can continuously schedule pairs of activate and precharge commands associated with one or more ranks. In some situations, the memory system opens a bank based on an activate command and closes the bank via a corresponding precharge command without having performed a write or read operation. These unutilized (or underutilized) activate and precharge commands can occur if there are no write or read requests that can be serviced while the memory system is in the current state and/or if the switching event occurs. The unnecessary opening and closing of banks within the memory system can waste power and increase overall power consumption.

To address this issue, techniques and apparatuses are described for performing active command regulation. In example aspects, a memory controller includes a regulator that performs active command regulation. The regulator detects one or more conditions associated with an impending switching event that causes the memory controller to switch states (e.g., switch between a write state and a read state). Based on this detection, the regulator prevents the releasing of requests and the scheduling of activate (and corresponding precharge) commands prior to the occurrence of the switching event. This blocking mechanism avoids the scheduling of extra activate and precharge commands that can become unutilized (e.g., commands that occur without a corresponding data transfer). Through active command regulation, the memory controller can improve a power efficiency of a memory system while maintaining operational efficiency.

### Operating Environment

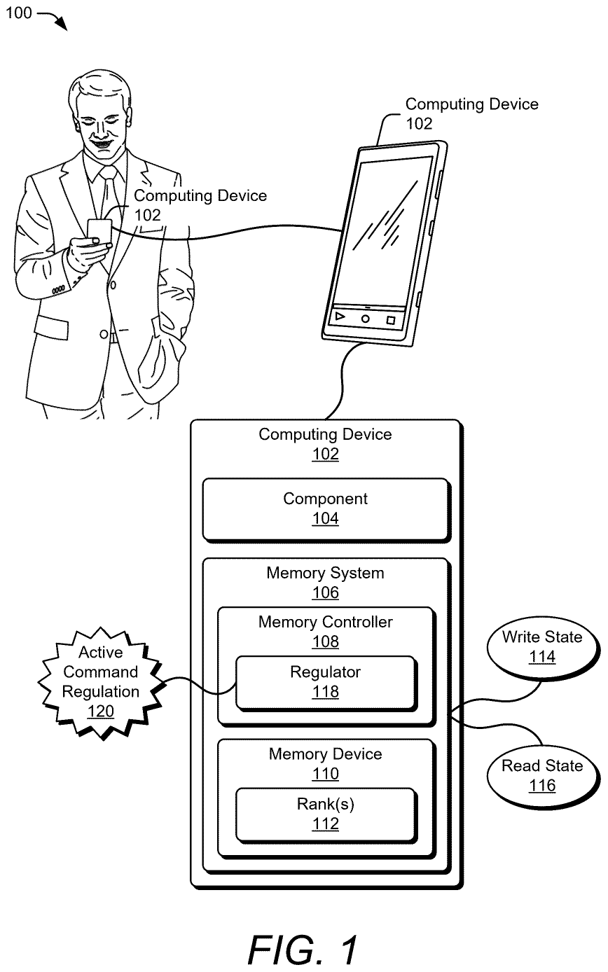

FIG. 1 is an illustration of an example environment 100 in which active command regulation can be implemented. In the example environment 100, a computing device 102 provides features and/or services to a user. Although depicted as a smartphone, the computing device 102 can include other types of devices, including a desktop computer, a tablet, a laptop, a television, a computing watch, computing glasses, a gaming system, a microwave, or a vehicle. Other devices may also be used, such as a home service device, a smart speaker, a smart thermostat, a baby monitor, a Wi-Fi® router, a drone, a trackpad, a drawing pad, a netbook, an e-reader, a home automation and control system, a wall display, and another home appliance. Note that the computing device 102 can be wearable, non-wearable but mobile, or relatively immobile (e.g., desktops and appliances).

The computing device 102 includes at least one component 104 and at least one memory system 106. The component 104 utilizes the memory system 106 for storing data. Example components 104 can include a processor, a central processing unit (CPU), a graphics processing unit (GPU), a tensor processing unit (TPU), a neural processing unit (NPU), an image processing unit (IPU), a modem, a digital signal processor (DSP), a sensor, and so forth. The component 104 sends a request to the memory system 106 that causes the memory system 106 to store new data and/or to retrieve stored data.

The memory system 106 includes at least one memory controller 108 and at least one memory device 110. The memory controller 108 provides a high-level interface between the component 104 and the memory device 110. The memory device 110 can include, for example, a dynamic random-access memory (DRAM) die or module (e.g., Low-Power Double Data Rate (LPDDR) DRAM). Generally speaking, the memory device 110 stores data for the computing device 102. The memory device 110 can be implemented with at least one rank 112. In some implementations, the memory device 110 has multiple ranks (e.g., two or more ranks 112).

The memory system 106, including the memory controller 108 and the memory device 110, can selectively be in a write state 114 or a read state 116. During the write state 114, the memory controller 108 can send write commands to the memory device 110. Based on the write commands, the memory device 110 performs write operations. During the read state 116, the memory controller 108 can send read commands to the memory device 110. The memory device 110 performs read operations based on the read commands. Over time, the memory system 106 can switch from the write state 114 to the read state 116 and/or can switch from the read state 116 to the write state 114. A time at which the memory system 106 switches between the write and read states 114 and 116 is referred to as a switching event.

The memory controller 108 includes at least one regulator 118 capable of performing active command regulation 120. Through active command regulation 120, the regulator 118 detects one or more conditions associated with an impending switching event that causes the memory controller 108 to switch states (e.g., switch between the write state 114 and the read state 116). Based on this detection, the regulator prevents the releasing of requests and the scheduling of activate (and corresponding precharge) commands prior to the occurrence of the switching event. This preemptive halting avoids the scheduling of extra activate and precharge commands that can become unutilized (e.g., commands that occur without a corresponding data transfer). Through active command regulation 120, the memory controller 108 can improve a power efficiency of the memory system 106 while maintaining operational efficiency.

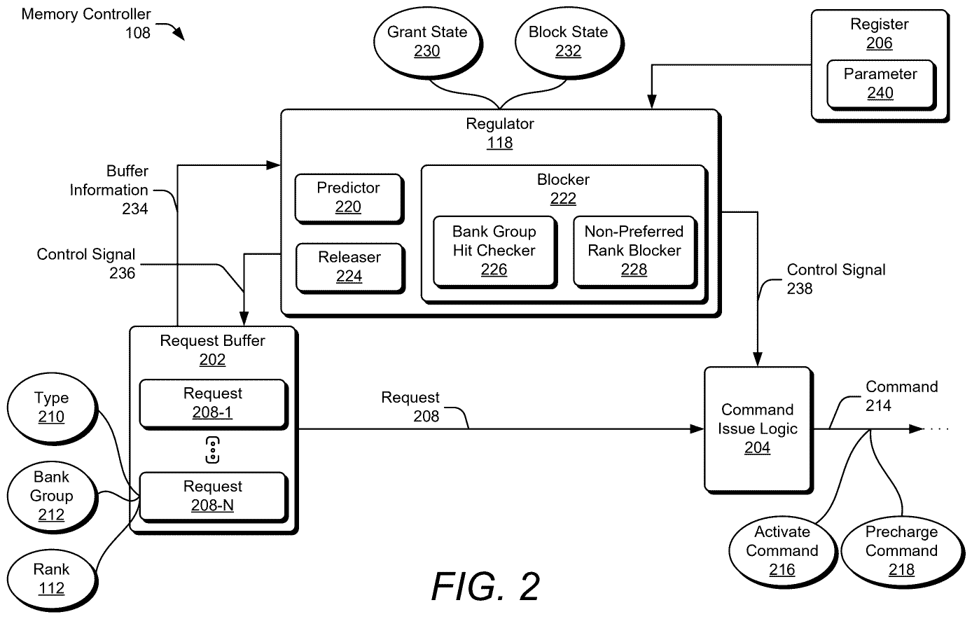

In example implementations, the active command regulation 120 causes there to be a consistent “quiet window” where no additional activate (and precharge) commands are issued prior to a switching event. This quiet window can enable the memory system 106 to reduce power consumption by 20% or more at a data rate of approximately 800 megabits per second in comparison to other memory systems that do not implement active command regulation 120. The regulator 118 is further described with respect to FIG. 2.

FIG. 2 illustrates an example implementation of a memory controller 108 with a regulator 118 capable of performing active command regulation 120. In the depicted configuration, the memory controller 108 comprises at least one request buffer 202, at least one regulator 118, at least one command issue logic 204, and at least one register 206. The request buffer 202 is coupled to the component 104 (not shown), the regulator 118, and the command issue logic 204. In example implementations, the request buffer 202 is implemented using one or more queues. Within the one or more queues, the request buffer 202 stores requests 208 that are received from the component 104 and are to be serviced by the memory system 106, such as requests 208-1 to 208-N where N represents a positive integer. The requests 208 can be associated with a particular type 210 (e.g., a write request or a read request), a particular bank group 212, and/or a particular rank 112. If the request buffer 202 includes multiple queues, different queues can be associated with the different types 210 (e.g., a write queue and a read queue). Additionally or alternatively, the different queues can be associated with different priority levels. In an example implementation, the request buffer 202 can be implemented using a write queue, a read queue, a queue associated with a first priority, another queue associated with a second priority that is less than the first priority, or some combination thereof.

The command issue logic 204 is coupled to the request buffer 202 and the regulator 118. The command issue logic 204 can be implemented using any combination of software, hardware, firmware, fixed logic circuitry, and so forth. The command issue logic 204 generates and sends commands 214 to the memory device 110. Example commands 214 can include activate commands 216 and precharge commands 218.

The regulator 118 is coupled to the request buffer 202, the command issue logic 204, and the register 206. The regulator 118 can be implemented using any combination of software, hardware, firmware, fixed logic circuitry, and so forth. The regulator 118 can be implemented with at least one predictor 220, at least one blocker 222, and/or at least one releaser 224. The predictor 220 monitors the request buffer 202 and estimates when a next switching event may occur. In example implementations, the predictor 220 can be implemented using at least one comparator.

The blocker 222 causes the command issue logic 204 to halt the sending of activate commands 216 and corresponding precharge commands 218 based on one or more blocking conditions being satisfied. The blocker 222 also blocks requests 208 from being released from the request buffer 202. In some implementations, the blocker 222 prevents the command issue logic 204 from sending activate and precharge commands 216 and 218 for a first quantity of clock cycles (e.g., after a first time interval). In an example implementation, the first quantity of clock cycles can be an integer value within a tunable range, such as a value between 5 and 15 (e.g., 10). In example implementations, the blocker 222 can be implemented with at least one comparator and a timer or a counter.

The blocker 222 can also include a bank group hit checker 226 and/or a non-preferred rank blocker 228. The bank group hit checker 226 checks for bank group diversity before engaging the blocking mechanism. If the quantity of requests 208 across different bank groups 212 is greater than or equal to a bank group limit, the bank group hit checker 226 can block the scheduling of additional activate and precharge commands 216 and 218.

The non-preferred rank blocker 228 checks for rank diversity before engaging the blocking mechanism. The non-preferred rank blocker 228 can halt the granting of activate and precharge commands 216 and 218 for requests 208 associated with a non-preferred rank 112. The non-preferred rank represents a rank 112 that currently has a lower priority compared to a preferred rank. Over time, a rank 112 can switch between being a preferred rank and a non-preferred rank. If the quantity of requests 208 stored within the request buffer 202 is greater than or equal to a non-preferred rank limit, the non-preferred rank blocker 228 can block the scheduling of additional activate and precharge commands 216 and 218 that are associated with the non-preferred rank 112. In an example implementation, the non-preferred rank limit can be an integer value within a tunable range, such as a value between 1 and 7 (e.g., 1 or 2).

The regulator 118 enables the scheduling of activate commands 216 (and corresponding precharge commands 218) to resume after a second quantity of clock cycles (e.g., after a second time period). In an example implementation, the second quantity of clock cycles can be an integer value within a tunable range, such as a value between 1 and 7 (e.g., 4). In more detail, the releaser 224 at least temporarily stops or disables the blocker 222. In example implementations, the releaser 224 can detect the completion of a switching event and release the blocker 222 based on this detection.

The register 206 stores one or more parameters 240 that can be referenced by the regulator 118 to perform aspects of active command regulation 120. Example parameters 240 can include the first quantity of clock cycles, the second quantity of clock cycles, one or more thresholds referenced by the predictor 220, the blocker 222, or the releaser 224, and so forth. In some implementations, a value of the parameter 240 is predetermined and fixed. In other implementations, the value of the parameter 240 can dynamically change over time to adapt to different situations and/or to realize different levels of performance. Some parameters 240 can be associated with a range of values, including a minimum value and a maximum value.

To perform active command regulation 120, the regulator 118 can selectively be in a grant state 230 or a block state 232. The grant state 230 enables the memory controller 108 to operate as normal. This means that the request buffer 202 can release requests 208 to the command issue logic 204, and the command issue logic 204 can schedule commands 214, including activate and precharge commands 216 and 218. Alternatively, the regulator 118 can be in the block state 232. While in the block state 232, the regulator 118 prevents the request buffer 202 from releasing requests 208 and prevents the command issue logic 204 from scheduling activate and precharge commands 216 and 218 that will be unutilized.

During operations, the request buffer 202 receives and stores each request 208 until the memory controller 108 can service the request 208. The regulator 118 monitors the request buffer 202 and gathers buffer information 234 about the request buffer 202. Example types of buffer information 234 can include a quantity of requests 208 of a particular type 210 (e.g., write requests or read requests) that have been released, a quantity of requests 208 of a particular type 210 that are currently stored by the request buffer 202, the quantity of requests 208 of a particular type 210 that are associated with a particular bank group 212, and/or the quantity of requests 208 of a particular type 210 that are associated with a non-preferred rank. The regulator 118 also generates control signals 236 and 238. The control signal 236 can selectively enable or disable the releasing of requests 208 by the request buffer 202 to the command issue logic 204. The control signal 238 can selectively enable or disable the scheduling of activate and precharge commands 216 and 218 by the command issue logic 204.

Consider an example situation in which the regulator 118 is in the grant state 230 during a first time interval. During this time interval, the request buffer 202 releases requests 208 to the command issue logic 204. The command issue logic 204 generates commands 214 to service the released request 208, including at least one activate command 216 and at least one precharge command 218. While monitoring the request buffer 202, the predictor 220 and/or the blocker 222 detects that a switching event is going to occur. Based on this detection, the blocker 222 causes the regulator 118 to switch from the grant state 230 to the block state 232 during a second time interval.

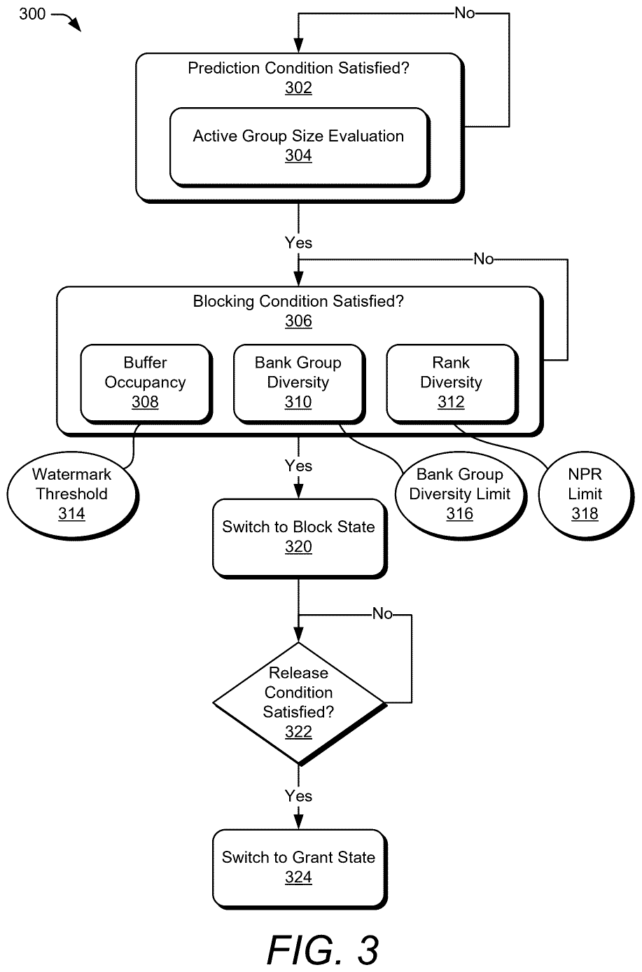

During the second time interval, the regulator 118 uses the control signals 236 and 238 to temporarily halt the releasing of requests 208 by the request buffer 202 and to temporarily halt the scheduling of activate and precharge commands 216 and 218 that would be unutilized. At a third time period and after the switching event occurs, the releaser 224 causes the regulator 118 to switch from the block state 232 to the grant state 230. Based on the grant state 230 and using the control signals 236 and 238, the regulator 118 causes the request buffer 202 to resume releasing requests 208 and causes the command issue logic 204 to resume scheduling commands 214. The regulator 118 can dynamically switch between the grant state 230 and the block state 232 based on different criteria, as further described with respect to FIG. 3.

FIG. 3 illustrates an example flow diagram 300 for performing active command regulation 120. Some of the conditions evaluated within the flow diagram 300 can vary depending on whether the memory controller 108 is in the write state 114 (e.g., servicing write requests) or in the read state 116 (e.g., servicing read requests). At startup, the regulator 118 is in the grant state 230.

At 302, the regulator 118 determines if a prediction condition is satisfied. For example, the predictor 220 receives the buffer information 234 and determines an active group size based on the buffer information 234. Consider a situation in which the memory controller 108 can selectively be in a first state (e.g., the write state 114) that services a first type 210 of requests 208 (e.g., write requests) or a second state (e.g., the read state 116) that services a second type 210 of requests 208 (e.g., read requests). In this case, the predictor 220 calculates the active group size based on a summation of a quantity of requests 208 corresponding to the active type 210 that have been released by the request buffer 202 and a quantity of requests 208 corresponding to the active type 210 that are stored by the request buffer 202. The quantity of requests 208 corresponding to the active type 210 can exclude requests associated with a mode register (e.g., a mode-register write request or a mode-register read request).

The predictor 220 evaluates the active group size at 304. In this case, the predictor 220 compares the active group size to a first threshold, which can be stored as a parameter 240 within the register 206. If the active group size is greater than or equal to the first threshold, the prediction condition is satisfied 302 and the flow diagram progresses to 306. A value of the first threshold can vary depending on the state of the memory controller 108. In some examples, the first threshold can have any value within a tunable range, such as any value between one and seven (e.g., one).

At 306, the regulator 118 determines if a blocking condition is satisfied. Example blocking conditions can be associated with an occupancy 308 of the request buffer 202 (buffer occupancy 308), bank group diversity 310, and/or rank diversity 312. By evaluating the buffer occupancy 308, the bank group diversity 310, and/or the rank diversity 312, the regulator 118 can detect an impending switching event and activate the blocking mechanism to conserve power.

Consider a first situation in which the memory controller 108 is in the read state 116 and can service read requests. To evaluate the buffer occupancy 308, the blocker 222 can determine an occupancy of a write queue that is implemented as part of the request buffer 202. In more detail, the blocker 222 compares the quantity of write requests to a first watermark threshold 314 (e.g., a high-watermark threshold). If the quantity of write requests is greater than or equal to the first watermark threshold 314, the blocking condition is satisfied at 306 and the flow diagram 300 progresses to 320.

Consider a second situation in which the memory controller 108 is in the write state 114 and can service write requests. To evaluate the occupancy status 308, the blocker 222 evaluates an occupancy of a read queue that is implemented as part of the request buffer 202. In more detail, the blocker 222 compares the quantity of read requests to a second watermark threshold 314 (e.g., a low-watermark threshold). In some implementations, the second watermark threshold 314 can be set to a low value, such as one. If the quantity of read requests is greater than or equal to the second watermark threshold 314, the blocking condition is satisfied at 306 and the flow diagram 300 progresses to 320.

Additionally or alternatively, the blocker 222 (or more specifically the bank group hit checker 226) checks for bank group diversity 310 by calculating a quantity of requests 208 corresponding to the active type 210 that are stored by the request buffer 202 for each bank group 212, which is referred to as bank-group page hits. If a summation of the bank-group page hits is greater than or equal to a bank group diversity limit 316, the blocking condition is satisfied at 306 and the flow diagram progresses to 320. In some implementations, the bank-group page hits for each bank group can be hard limited. Additionally or alternatively, the bank-group page hits can be specific to each rank 112. The bank group diversity limit 316 can be appropriately set based on the quantity of bank groups 212 and/or a value of the hard limit.

Additionally or alternatively, the blocker 222 (or more specifically the non-preferred rank blocker 228) checks for rank diversity 312 by calculating a quantity of requests 208 corresponding to the active type 210 that are stored by the request buffer 202 and are associated with a non-preferred rank. This quantity is referred to as non-preferred rank page hits. If the non-preferred rank page hits is greater than or equal to a non-preferred rank limit 318 (NPR limit 318), the blocking condition is satisfied at 306 and the flow diagram progresses to 320.

At 320, the regulator 118 transitions from the grant state 230 to the block state 232. This stops the scheduling of extra activate and precharge commands 216 and 218 that can become unutilized (e.g., commands that occur without a corresponding data transfer). In some implementations, the releaser 224 can initiate a timer to determine when to release the blocker 222.

At 322, the releaser 224 determines if a release condition is satisfied. For example, the releaser 224 can determine if the timer that was set at 320 has expired. Once the timer has expired, the releaser 224 determines that the release condition is satisfied, and the flow diagram 300 progresses to 324. As another example, the releaser 224 can detect a completion of the switching event or receive an indication of the completion of the switching event. Based on this detection or indication, the releaser 224 determines that the release condition is satisfied, and the flow diagram 300 progresses to 324. At 324, the regulator 118 transitions from the block state 232 to the grant state 230. The process can further continue and repeat steps 302 to 324.

An example of conditional logic that implements the active command regulation 120 is shown below:
if (Rd_state or Rd_to_Wr_switch_state) {
   if {((read_active_group_size>=CSR_read_active_group_min_threshold) & ((write_request_buffer_occupancy>=CSR_wr_req_threshold_occupancy∥Read_BG_page_hits>=CSR_BG_diversity_limit)))}
      Activate block state and stop granting activate commands for read requests for CSR_Act_Command_Stop_Cycles else if {(Page_hit_count_nprk in read queue>=CSR_Nprk_Limit) & (req_rank!=pref_rank)}
      Activate block state and stop granting activate commands for read requests
   else {
      Activate grant state and start granting activate commands for read requests for CSR_Act_Command_Release_Cycles}
else if {(Wr_state or Wr_to_Rd_switch_state)
   if {((write_active_group_size>=CSR_write_active_group_min_threshold) & ((read_request_buffer_has_non_zero_occupancy)∥
   (write_BG_page_hits>=CSR_BG_diversity_limit)))}
      Activate block state and stop granting activate commands for write requests for CSR_Act_Command_Stop_Cycles
   else if {(Page_hit_count_nprk in write queue>=CSR_Nprk_Limit) & (req_rank!=pref_rank)}
      Activate block state and stop granting activate commands for write requests else{
      Activate grant state and start granting activate commands for write requests for CSR_Act_Command_Release_Cycles}
         where Rd_state represents read state 116, Wr_state represents the write state 114, Rd_to_Wr_switch_state and Wr_to_Rd_switch_state is associated with the switching event 408, the read_active_group_size and the write_active_group_size represents the active group size for read and write requests 410 and 402, CSR_read_active_group_min_threshold represents the first threshold described at 304 in FIG. 3, CSR_wr_req_threshold_occupancy represents the first watermark threshold 314, read_BG_page_hits and write_BG_page_hits represents the bank-group page hits for read and write requests 410 and 402, the CSR_BG_diversity_limit represents the bank group diversity limit 316, page_hit_count_nprk represents the non-preferred rank page hits described with respect to rank diversity 312 in FIG. 3, and CSR_Nprk_Limit represents the non-preferred rank limit 318.

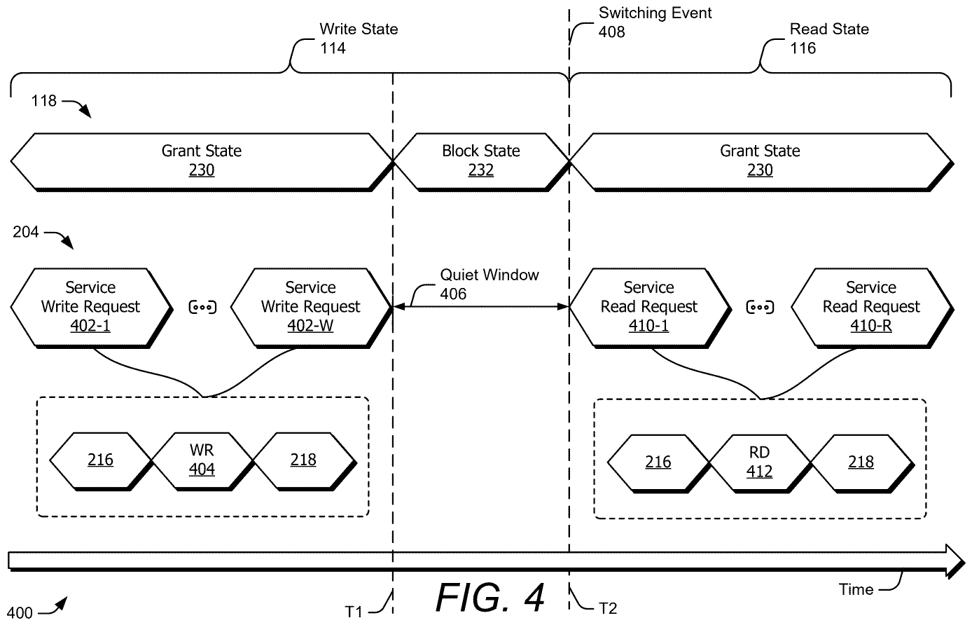

FIG. 4 illustrates an example timing diagram 400 for performing aspects of active command regulation 120, with time progressing from left to right. At a beginning of the example timing diagram 400, the memory controller 108 is in the write state 114. The regulator 118 is also in the grant state 230. Based on the write state 114 and the grant state 230, the command issue logic 204 services a group of write requests, such as write requests 402-1 to 402-W, where W represents a positive integer. To service each write request 402, the command issue logic 204 schedules (e.g., issues, transmits, or sends) an activate command 216, a write command 404 (WR 404), and a precharge command 218.

At time T1, the regulator 118 switches from the grant state 230 to the block state 232. This causes the command issue logic 204 to halt the scheduling of additional activate and precharge commands 216 and 218. As such, a “quiet” window 406 can be observed across the command bus in which no unused activate and precharge commands 216 and 218 are scheduled.

At time T2, a switching event 408 occurs. The switching event 408 enables the memory controller 108 to transition from the write state 114 to the read state 116. Although illustrated as a single instance in FIG. 4, the switching event 408 can occur over a certain time period. Once the switching event 408 is complete and the regulator transitions from the block state 232 to the grant state 230, the command issue logic 204 services a group of read requests 410, such as read requests 410-1 to 410-R, where R represents a positive integer. To service each read request 410, the command issue logic 204 schedules an activate command 216, a read command 412 (RD 412) and a precharge command 218. Although not shown in FIG. 4, the regulator 118 can switch from the grant state 230 to the block state 232 and a second quiet window 406 can occur prior to a second switching event 408 in which the memory controller 108 switches from the read state 116 to the write state 114.

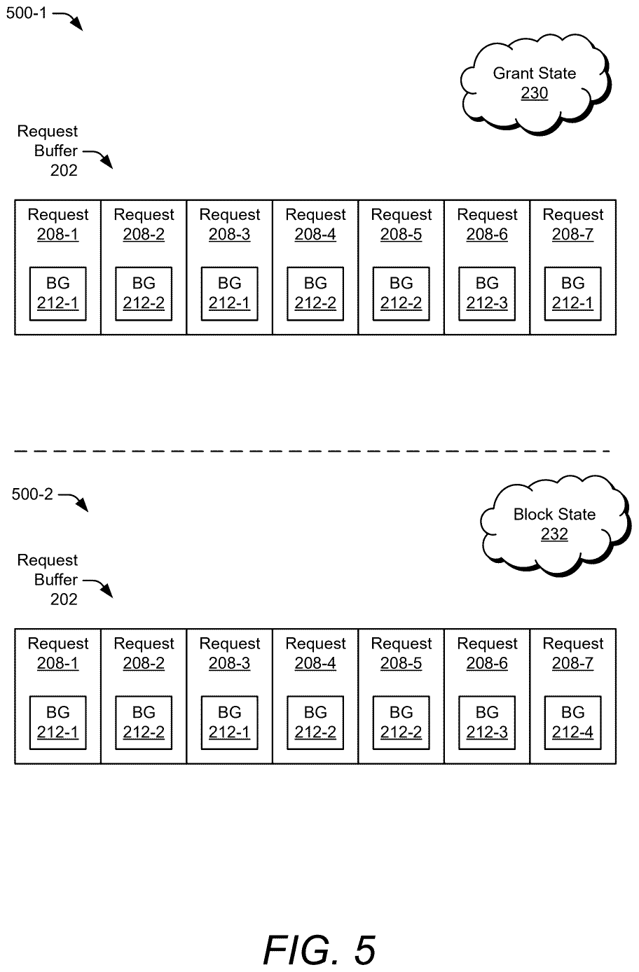

FIG. 5 illustrates example situations 500-1 and 500-2 in which active command regulation 120 can be implemented to support bank group diversity 310. At 500-1 and 500-2, the request buffer 202 stores requests 208-1, 208-2, 208-3, 208-4, 208-5, 208-6, and 208-7. Although only seven requests 208 are depicted in these examples, it is to be understood that the request buffer 202 can store any quantity of requests 208, including more than seven requests 208. In these examples, the memory system 106 has four different bank groups 212-1, 212-2, 212-3, and 212-4. These techniques can be applied to other memory systems 106 having a different quantity of bank groups 212. A threshold for evaluating the blocking condition associated with bank group diversity 310 (e.g., the bank group diversity limit 316) is set to four as an example.

At 500-1, the requests 208-1, 208-3, and 208-7 are associated with the first bank group 212-1. Also, the requests 208-2, 208-4, and 208-5 are associated with the second bank group 212-2. Additionally, the request 208-6 is associated with the third bank group 212-3. In this case, a first bank group page hit for the first bank group 212-1, a second bank group page hit for the second bank group 212-2, and a third bank group page hit for the third bank group 212-3 are equal to one to indicate that the request buffer 202 has at least one request 208 associated with the corresponding bank group 212. A fourth bank group page hit for the fourth bank group 212-4 is equal to zero to indicate that the request buffer 202 does not store a request 208 associated with the fourth bank group 212-4. In this example, a summation of the bank-group page hits for each of the banks 212 is equal to three. The bank group hit checker 226 compares this summation to the bank group diversity limit 316. Since the summation is less than the bank group diversity limit 316, the bank group hit checker 226 determines that the blocking condition is not satisfied and the regulator 118 remains in the grant state 230.

At 500-2, the requests 208-1 and 208-3 are associated with the first bank group 212-1, and the requests 208-2, 208-4, and 208-5 are associated with the second bank group 212-2. Additionally, the requests 208-6 and 208-7 are associated with the third bank group 212-3 and the fourth bank group 212-4, respectively. In this example, a summation of the bank-group page hits for each of the banks 212 is equal to four. The bank group hit checker 226 compares this summation to the bank group diversity limit 316. Since the summation is greater than or equal to the bank group diversity limit, the bank group hit checker 226 determines that the blocking condition is satisfied and the regulator 118 transitions to the block state 232.

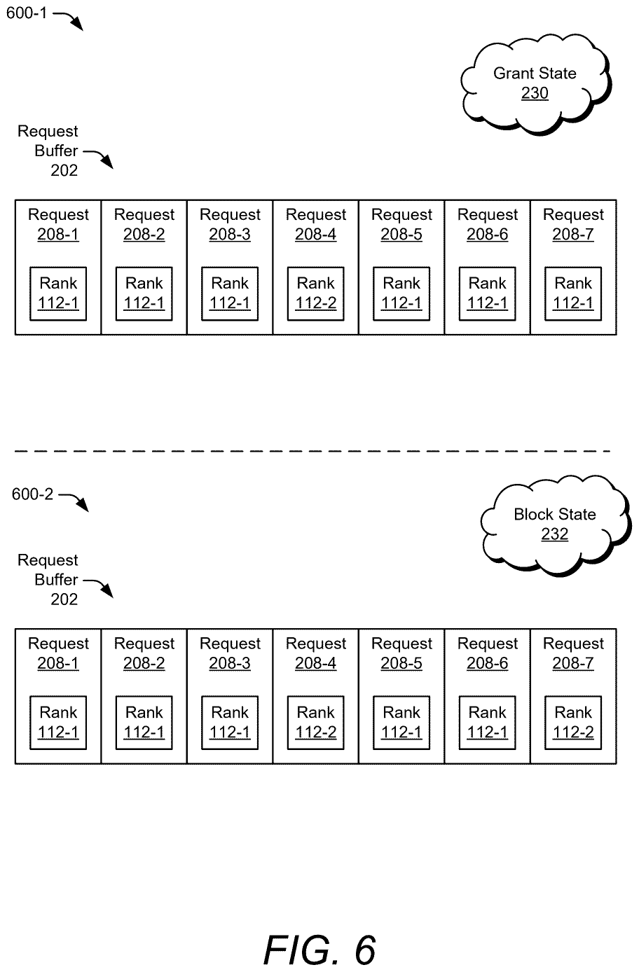

FIG. 6 illustrates example situations 600-1 and 600-2 in which active command regulation 120 can be implemented to support rank diversity 312. At 600-1 and 600-2, the request buffer 202 stores requests 208-1, 208-2, 208-3, 208-4, 208-5, 208-6, and 208-7. Although only seven requests 208 are depicted in these examples, it is to be understood that the request buffer 202 can store any quantity of requests 208, including more than seven requests 208. In these examples, the memory system 106 supports two ranks 112-1 and 112-2. These techniques can be applied to other memory systems 106 that support a different quantity of ranks 112. A threshold for evaluating the blocking condition associated with rank diversity 312 (e.g., the non-preferred rank limit 318) is set to two as an example. Also, the first rank 112-1 is considered to be a preferred rank and the second rank 112-2 is considered to be a non-preferred rank.

At 600-1, the requests 208-1 to 208-3 and 208-5 to 208-7 are associated with the first rank 112-1. Also, the request 208-4 is associated with the second rank 112-2. In this case, the quantity of requests 208 that are associated with the second rank 112-2 (e.g., the non-preferred rank) is equal to one (e.g., the non-preferred rank page hits is equal to one). The non-preferred rank blocker 228 compares the non-preferred rank page hits to the non-preferred rank limit 318. Since the non-preferred rank page hits is less than the non-preferred rank limit 318, the non-preferred rank blocker 228 determines that the blocking condition is not satisfied and the regulator 118 remains in the grant state 230.

At 600-2, the requests 208-1 to 208-3, 208-5, and 208-6 are associated with the first rank 112-1. Also, the requests 208-4 and 208-7 are associated with the second rank 112-2. In this case, the quantity of requests 208 that are associated with the second rank 112-2 is equal to two (e.g., the non-preferred rank page hits is equal to two). The non-preferred rank blocker 228 compares the non-preferred rank page hits to the non-preferred rank limit 318. As the non-preferred rank page hits is greater than or equal to the non-preferred rank limit 318, the non-preferred rank blocker 228 determines that the blocking condition is satisfied and the regulator 118 transitions to the block state 232.

### Example Method

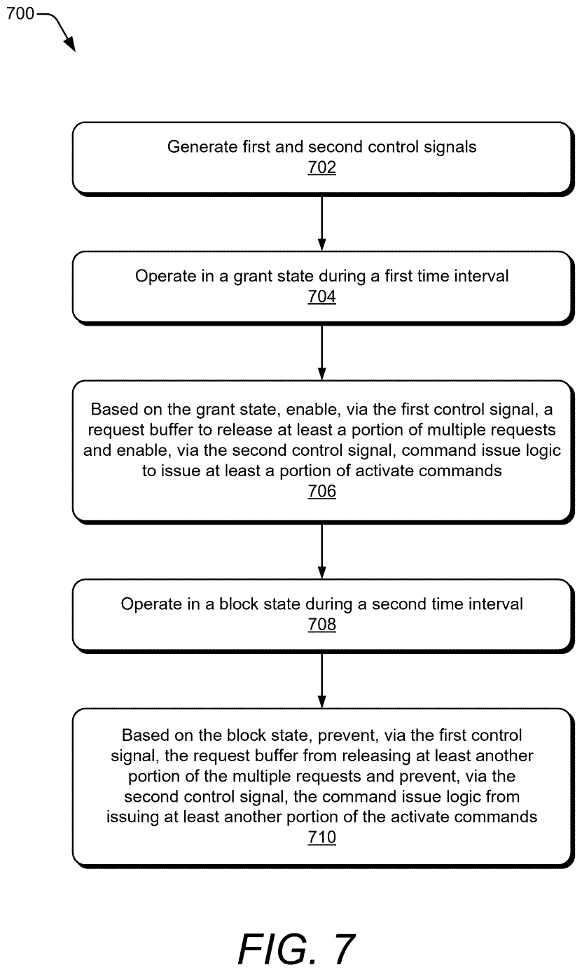

FIG. 7 depicts an example method 700 for implementing aspects of active command regulation. Method 700 is shown as a set of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environment 100 of FIG. 1, and entities detailed in FIG. 2, reference to which is made for example only. The techniques are not limited to performance by one entity or multiple entities operating on one device.

At 702, first and second control signals are generated. For example, the regulator 118 generates the first control signal 236 and the second control signal 238, as shown in FIG. 2. The regulator 118 provides the first control signal 236 to the request buffer 202. The first control signal 236 controls an operational state of the request buffer 202 (e.g., enables the request buffer 202 to release one or more requests 208 or prevents the request buffer 202 from releasing requests 208). The regulator 118 provides the second control signal 238 to the command issue logic 204. The second control signal 238 controls an operational state of the command issue logic 204 (e.g., enables the command issue logic 204 to issue commands 214 (e.g., pairs of activate and precharge commands 216 and 218) to service the released requests 208 or prevents the command issue logic 204 from issuing commands 214).

At 704, the regulator operates in a grant state during a first time interval. For example, the regulator 118 operates in the grant state 230 during a first time interval.

At 706 based on the grant state, a request buffer is enabled, via the first control signal, to release at least a portion of multiple requests. Also, based on the grant state, command issue logic is enabled, via the second control signal, to issue at least a portion of activate commands. For example, the regulator 118 enables, based on the grant state 230 and via the first control signal 236, the request buffer 202 to release at least a portion of the multiple requests 208. The regulator 118 also enables, based on the grant state 230 and via the second control signal 238, the command issue logic 204 to issue at least a portion of the activate commands 216 (and at least a portion of the corresponding precharge commands 218).

At 708, the regulator operates in a block state during a second time interval. For example, the regulator 118 operates in the block state 232 during the second time interval.

At 710, based on the block state, the request buffer is prevented, via the first control signal, from releasing at least another portion of the multiple requests. Also, based on the block state, the command issue logic is prevented, via the second control signal, from issuing at least another portion of the activate commands. For example, the regulator 118 prevents, based on the block state 232 and via the first control signal 236, the request buffer 202 from releasing at least another portion of the multiple requests 208. The regulator 118 also prevents, based on the block state 232 and via the second control signal 238, the command issue logic 204 from issuing at least another portion of the activate commands 216 (and at least another portion of the corresponding precharge commands 218). Through active command regulation 120, the memory controller 108 can improve a power efficiency of a memory system 106 while maintaining operational efficiency.

### Conclusion

Although techniques for performing active command regulation have been described in language specific to features and/or methods, it is to be understood that the subject of the appended claims is not necessarily limited to the specific features or methods described. Rather, the specific features and methods are disclosed as example implementations of performing active command regulation.

What is claimed is:

1. A memory controller comprising:
a request buffer configured to:
store multiple requests; and
release the multiple requests based on a first control signal;
command issue logic configured to issue, based on a second control signal, activate commands to a memory device to service the multiple requests that are released by the request buffer; and
a regulator coupled to the request buffer and the command issue logic, the regulator configured to:
generate the first and second control signals;
be in a grant state during a first time interval;
based on the grant state, enable, via the first control signal, the request buffer to release a first portion of the multiple requests and enable, via the second control signal, the command issue logic to issue a first portion of the activate commands;
be in a block state during a second time interval; and
based on the block state, prevent, via the first control signal, the request buffer from releasing a second portion of the multiple requests and prevent, via the second control signal, the command issue logic from issuing a second portion of the activate commands.

2. The memory controller of claim 1, wherein the regulator is further configured to prevent the second portion of the activate commands from being issued without a corresponding data transfer.

3. The memory controller of claim 1, wherein:
the command issue logic is configured to issue, based on the second control signal, precharge commands to the memory device to service the multiple requests that are released by the request buffer; and
the regulator is further configured to:
enable, based on the grant state and via the second control signal, the command issue logic to issue a first portion of the precharge commands; and
prevent, based on the block state and via the second control signal, the command issue logic from issuing a second portion of the precharge commands.

4. The memory controller of claim 1, wherein the regulator is further configured to:
monitor, during the first time interval, the request buffer;
detect, during the first time interval and based on the monitoring, at least one condition associated with a switching event; and
transition from the grant state to the block state based on the detection and prior to an occurrence of the switching event.

5. The memory controller of claim 4, wherein:
the memory controller is in a first state and is configured to service a first type of request based on the first state; and
the regulator is further configured to:
determine that an active group size is greater than or equal to a first threshold;
determine that a quantity of requests of a second type that are stored in the request buffer is greater than or equal to a first watermark threshold, the second type being different than the first type; and
detect the at least one condition based on the determination of the active group size and the determination of the quantity of requests of the second type.

6. The memory controller of claim 4, wherein the regulator is further configured to:
determine that an active group size is greater than or equal to a first threshold;
determine that a summation of bank-group page hits for each bank group is greater than or equal to a bank group diversity limit; and
detect the at least one condition based on the determination of the active group size and the determination of the summation.

7. The memory controller of claim 4, wherein the regulator is further configured to:
determine that a quantity of non-preferred rank page hits is greater than or equal to a non-preferred rank limit; and
detect the at least one condition based on the determination.

8. The memory controller of claim 4, wherein the regulator is further configured to:
detect, during the second time interval, a release condition; and
transition from the block state to the grant state based on the detection of the release condition.

9. The memory controller of claim 8, wherein the release condition comprises:
an expiration of a timer that was initiated at a beginning of the second time interval; or an indication of a completion of the switching event.

10. The memory controller of claim 4, wherein the switching event is associated with the memory controller transitioning from a first state that is capable of servicing a first type of request to a second state that is capable of servicing a second type of request that is different from the first type.

11. The memory controller of claim 10, wherein:
the first type of request comprises a read request and the second type of request comprises a write request; or
the first type of request comprises a write request and the second type of request comprises a read request.
